(19) United States
(12) Patent Application Publication
(10) Pub. No.: US 2022/0253508 A1
(43) Pub. Date: Aug. 11, 2022

(54) CONSECUTIVE APPROXIMATION CALCULATION METHOD, CONSECUTIVE APPROXIMATION CALCULATION DEVICE, AND PROGRAM

(71) Applicant: SHIMADZU CORPORATION, Kyoto-shi, Kyoto (JP)

(72) Inventors: Yusuke TAGAWA, Kyoto-shi (JP); Akira NODA, Kyoto-shi (JP); Wataru TAKAHASHI, Kyoto-shi (JP); Tetsuya KOBAYASHI, Kyoto-shi (JP)

(73) Assignee: SHIMADZU CORPORATION, Kyoto-shi, Kyoto (JP)

(21) Appl. No.: 17/294,181

(22) PCT Filed: Nov. 14, 2019
(86) PCT No.: PCT/JP2019/044657

§ 371 Date: Nov. 30, 2021

(30) Foreign Application Priority Data
Nov. 22, 2018 (JP) 2018-218944

(51) Int. Cl. G06F 17/17; G06T 11/00

(52) U.S. Cl. CPC G06F 17/17; G06T 11/003

(57) ABSTRACT

A computer calculates interference fringe phase estimated value data (30) of a phase-restored object image by performing iterative approximation calculation using interference fringe intensity data (10) measured by a digital holography apparatus and interference fringe phase initial value data (20), which is an estimated initial phase value of the image of the object. The interference fringe phase initial value data (20) is calculated by an initial phase estimator (300). The initial phase estimator (300) is constructed by implementing machine learning using interference fringe intensity data and the like for learning. The computer acquires reconfigured intensity data (40) and reconfigured phase data (50) by performing optical wave propagation calculation using the interference fringe phase estimation value data (30) of the image of the object acquired through phase restoration, and the interference fringe intensity data (10) used as input data for the initial phase estimator (300). This provides an iterative approximation calculation method and the like capable of making an initial value of a solution used in the iterative approximation calculation method a value close to the true value.

### TECHNICAL FIELD

The present invention relates to an iterative approximation calculation method, and an iterative approximation calculation device, and a program thereof.

### BACKGROUND ART

Conventionally, an iterative approximation calculation method for solving a relational expression of a model of problems that cannot be solved through numerical analysis, which includes the steps of: setting an arbitrary initial value (approximate solution) first, finding a more accurate solution using this initial value, and successively repeating this calculation until it converges to one solution, is well-known.

The iterative approximation calculation method described above is widely used in fields such as, for example, tomographic reconfiguration of data for nuclear medicine such as PET disclosed in Patent Document 1, estimation of scattered components of radiation using a radiation tomographic apparatus disclosed in Patent Document 2, compensation for missing data by tomographic imaging disclosed in Patent Document 3, and artifact reduction of reconfigured images using an X-ray CT apparatus disclosed in Patent Document 4.

### PRIOR ART DOCUMENTS

### Patent Documents

Patent Document 1: Japanese Patent No. 5263402
Patent Document 2: Japanese Patent No. 6123652
Patent Document 3: Japanese Patent No. 6206501
Patent Document 4: International Patent Publication WO 2017/029702

### DISCLOSURE OF THE INVENTION

### Problems to be Solved by the Invention

The closer the initial value of a solution used by the iterative approximation calculation method described above is to the true value, the less convergence to an incorrect local solution occurs, and moreover, the fewer the times of repeating calculation until it converges to the correct solution. However, conventionally, there is a problem that setting an appropriate initial value is difficult since various solutions can be found according to the problem to be solved.

To solve these problems, the present invention aims to provide an iterative approximation calculation method, an iterative approximation calculation apparatus, and a program thereof wherein the iterative approximation calculation method is able to set an initial value of a solution close to the true value.

### Means of Solving the Problems

An exemplary iterative approximation calculation method according to the present invention includes the step of: performing iterative approximation calculation so as to make an evaluation function either minimum or maximum. In said step, a learned model, which inputs a predetermined physical quantity to be used in the iterative approximation calculation, and outputs one or a plurality of initial values to be used in the iterative approximation calculation, is used.

Moreover, an exemplary iterative approximation calculation device according to the present invention includes a calculation unit for performing iterative approximation calculation so as to make an evaluation function either minimum or maximum. The calculation unit has a learned model, which inputs a predetermined physical quantity to be used in the iterative approximation calculation as input, and outputs one or a plurality of initial values to be used in the iterative approximation calculation.

Furthermore, an exemplary program according to the present invention is executed by a computer. The program includes the function of performing iterative approximation calculation so as to make an evaluation function either minimum or maximum. The iterative approximation calculation uses a learned model, which inputs a predetermined physical quantity to be used in the iterative approximation calculation, and outputs one or a plurality of initial values to be used in the iterative approximation calculation.

Further, an exemplary storage medium according to the present invention is a computer readable, non-temporary storage medium, and stores the exemplary program.

### Results of the Invention

According to the present invention, since a value close to the true value may be set as an initial value for iterative approximation calculation, convergence to an incorrect local solution may be prevented, and the times of repeating calculation necessary until converging to the correct solution may also be reduced.

### BRIEF DESCRIPTION OF DRAWINGS

FIG. 1 is a block diagram illustrating an exemplary functional configuration of a digital holography apparatus according to an embodiment of the present invention;

FIG. 2 is a block diagram illustrating an exemplary functional configuration of a computer used when performing iterative approximation calculation and the like;

FIG. 3 is a schematic diagram for describing a learning data generation step of generating learning data;

FIG. 4 is a flowchart giving exemplary operations of the computer when generating learning data;

FIG. 5 is a block diagram illustrating an exemplary functional configuration of the computer used when constructing an initial phase estimator;

FIG. 6 is a schematic diagram for describing a learning step of constructing the initial phase estimator;

FIG. 7 is a diagram for describing a convolutional neural network; and

FIG. 8 is a schematic diagram for describing an execution step of reconfiguring images.

### DESCRIPTION OF EMBODIMENTS

A preferred embodiment of the present invention is described in detail referencing the attached drawings. The embodiment will be described in the following order.

(1) Learning data generation step of generating learning data
(2) Learning step of constructing an initial phase estimator through machine learning using the learning data
(3) Execution step of reconfiguring an image through phase restoration of an object image using the initial phase estimator

<(1) Learning Data Generation Step>

To begin with, a learning data generation step of generating learning data is described. In the learning data generation step (1), learning data to be used when performing machine learning for constructing an initial phase estimator described later is generated. The learning data according to the embodiment includes training data, for example, and represents an example of a large data set having interference fringe intensity data and corresponding phase data or corresponding answer that has been estimated through iterative approximation calculation.

[Exemplary Configuration of Digital Holography Apparatus 100]

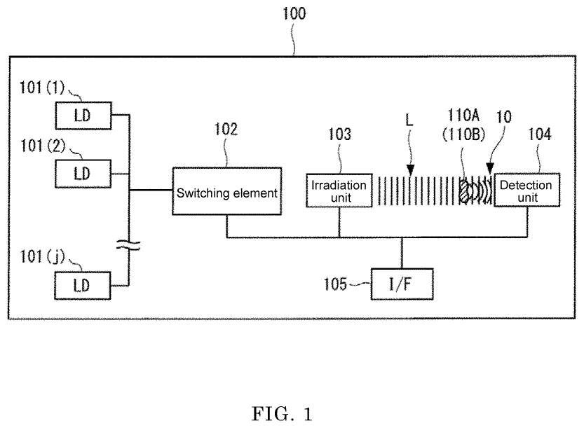

FIG. 1 illustrates an exemplary configuration of a digital holography apparatus 100 that generates a hologram of an object 110A.

As illustrated in FIG. 1, a digital holography apparatus 100 is a microscope, and includes j-number of laser diodes (LD) 101(1) to 101(j), a switching element 102, an irradiation unit 103, a detection unit 104, and an interface (I/F) 105.

The LDs 101(1) to 101(j) are respectively light sources for oscillating and emitting coherent lights, and are connected to the switching element 102 via optical fiber cables etc. The oscillating wavelengths λ(1) to λ(j) of the respective LDs 101(1) to 101(j) are set to increase in wavelength in this given order, for example.

The switching element 102 selects one of the LDs 101(1) to 101(j) used as light sources based on an instruction from a computer 200A etc., described later, connected via a network.

The irradiation unit 103 emits an illumination light L toward the object 110A etc. based on the one of the LDs 101(1) to 101(j) that is selected by the switching element 102. The object 110A is a cell etc.

The detection unit 104 is configured by a CCD image sensor, for example, and takes the image of an interference fringe (hologram) generated by the illumination light L emitted from the irradiation unit 103, and acquires interference fringe intensity data 10 of the image of the object 110A. This interference fringe intensity data 10 includes an interference fringe, which is generated by: optical waves that are diffracted by the object 110A and that are identified as object waves (arc-shaped lines on the right side of the object in the same drawing) and non-diffracted optical waves (including transmitted light) identified as reference waves (line segments on the right side of the object 110A) and then recorded.

[Exemplary Configuration of Computer 200A]

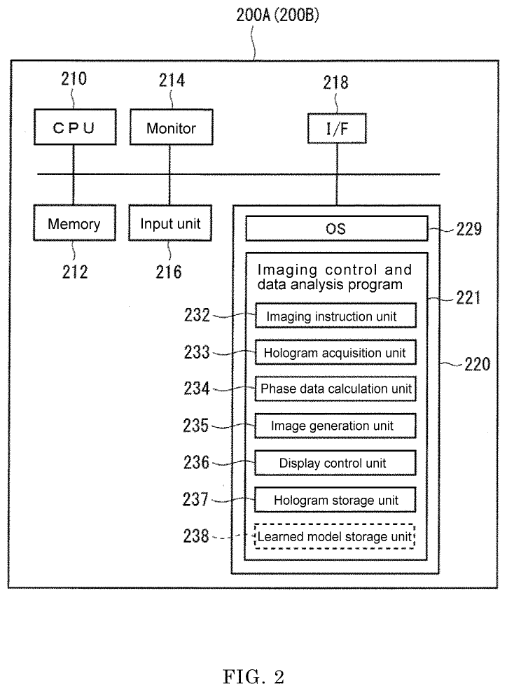

FIG. 2 illustrates an exemplary configuration of a computer 200A, which is an example of an iterative approximation calculation apparatus that performs iterative approximation calculation and optical wave propagation calculation.

As shown in FIG. 2, the computer 200A configures an exemplary calculation unit, and includes a CPU (Central Processing Unit) 210, which controls operations of the entire apparatus. Memory 212 including a volatile memory unit such as RAM (Random Access Memory) or the like, a monitor 214 including an LCD (Liquid Crystal Display) or the like, an input unit 216 including a keyboard and/or a mouse or the like, an interface 218, and a storage unit 220 are respectively connected to the CPU 210.

The interface 218 is structured communicable with the digital holography apparatus 100, transmitting an instruction of hologram imaging to the digital holography device 100, and receiving imaging data from the digital holography apparatus 100. The computer 200A and the digital holography apparatus 100 may be directly connected via a cable etc., or may be connected wirelessly. Moreover, it may have a structure allowing transfer of data due to an auxiliary storage unit using a semiconductor memory such as a USB (Universal Serial Bus) or the like.

The storage unit 220 is configured by volatile memory units, such as ROM (Read only Memory), flash memory, EPROM (Erasable Programmable ROM), HDD (Hard Disc Drive), or SSD (Solid State Drive) etc. An OS (Operating System) 229 and an imaging control/data analysis program 221 are stored in the storage unit 220.

The imaging control/data analysis program 221 is run executing functions of an imaging instruction unit 232, a hologram acquisition unit 233, a phase data calculation unit 234, an image generation unit 235, a display control unit 236, and a hologram storage unit 237, etc. The imaging control/data analysis program 221 is run performing iterative approximation calculation using a hologram generated by the digital holography apparatus 100, and has a function of regenerating the image of the object 110A so as to display it on a screen of the monitor 214. Moreover, the imaging control/data analysis program 221 has a function of controlling hologram imaging using the digital holography apparatus 100.

[Outline of Learning Data Generation Step]

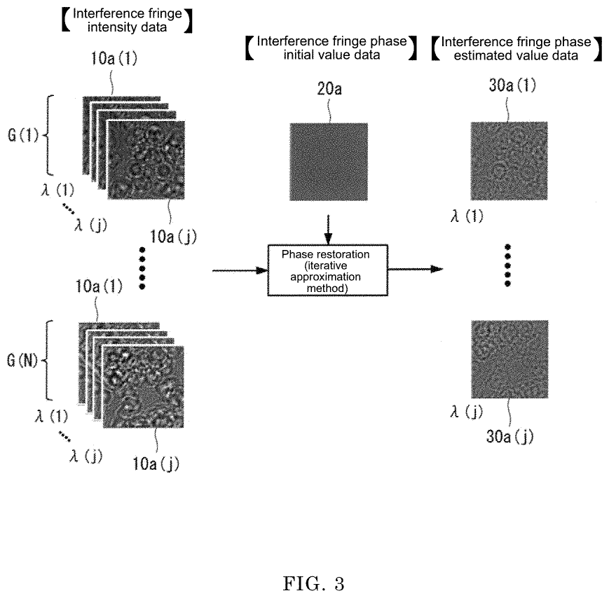

FIG. 3 is a diagram for describing an outline of a generation step of generating learning data. The digital holography apparatus 100 irradiates the object 110A with lights of the different wavelengths λ(1) to λ(j) from the respective light sources, acquires as a single data group G(1) interference fringe intensity data 10a(1) to 10a(j) having different patterns, and further acquires N-number of the data group G(N) through the same method. N is a positive integer.

Next, the computer 200A performs iterative approximation calculation using the acquired interference fringe intensity data groups G(1) to G(N) and interference fringe phase initial value data 20a, which is a preset initial phase value of the image of the object 110A. The initial phase value of the image of the object 110A may be set to an arbitrary value. With this embodiment, for example, all of the pixel values are set to zero as the initial phase value. Alternatively, the pixel values may be set randomly. The computer 200A calculates phase-restored interference fringe phase estimated data 30a(1) to 30a(j) for the respective data groups G(1) to G(N) by performing iterative approximation calculation.

With this embodiment, the interference fringe intensity data 10a(1) to 10a(j) having the respective wavelengths A acquired through actual measurement and the interference fringe phase estimated data 30a(1) to 30a(j) acquired through iterative approximation calculation are used as learning data when performing machine learning in order to construct an initial phase estimator 300. That is, with this embodiment, phase data acquired through successive calculation with the initial phase value set to a pixel value of zero etc. may be used as the learning data for the initial phase estimator 300. In order to prepare phase data close to the true value, it is preferable to perform successive calculations for a sufficient number of repeated times until the evaluation function becomes small enough, in the learning data generation step.

[Working Example of Iterative Approximation Calculation]

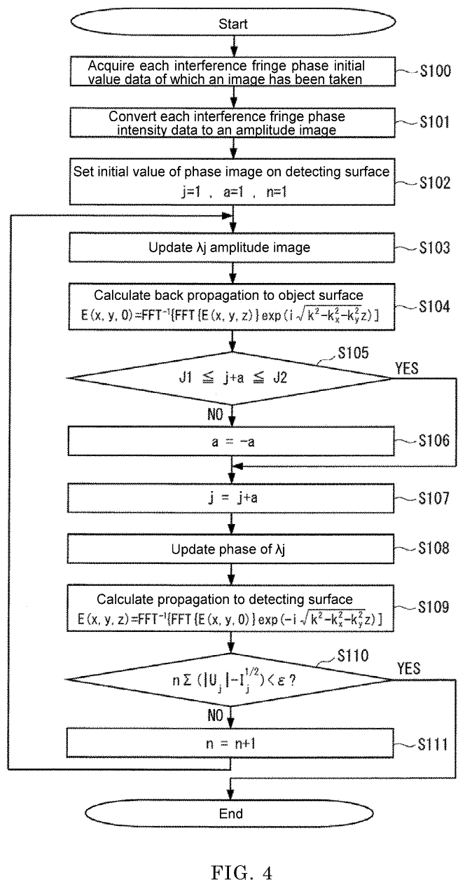

FIG. 4 is a flowchart giving exemplary operations of the computer 200A in the case of calculating the phase of the image of the object 110A through iterative approximation calculation. This will be described below while referencing FIGS. 1 to 3 etc.

In step S100, the computer 200A acquires interference fringe intensity data 10(1) of the image of the object 100A that is taken by the digital holography apparatus 100. The CPU 210 of the computer 200A stores the received interference fringe intensity data 10(1) in the hologram storage unit 237. In this manner, the computer 200A performs the hologram imaging described above for each of the wavelengths λ in order, acquires the interference fringe intensity data 10(1) to 10(j) corresponding to all of the wavelengths, and stores them in the hologram storage unit 237.

In step S101, the CPU 210 converts the multiple interference fringe intensity data 10(1) to 10(j) stored in the hologram storage unit 237 to amplitudes. Since a hologram is a distribution of intensity values, it cannot be applied as intensity data as is to Fourier transform to be used for optical wave propagation calculation described later. Therefore, the respective intensity values are converted to amplitude values in step S101. Conversion to amplitude is performed by calculating the square root of the respective pixel values.

In step S102, the CPU 210 sets j=1, a=1, and n=1 so as to set the interference fringe phase initial value data 20a, which is an initial phase value of the image of the object 110A on a detecting surface. With this embodiment, the initial phase value of the image of the object 110A is estimated using the initial phase estimator 300 having a learned model. Note that ‘j’ is an identifier of the LD 101, which is a light source of the illumination light L, where J1≤j≤J2, ‘a’ is a directional value, which is a value of either 1 or −1, and ‘n’ is the number of repeated times of calculation.

In step S103, the CPU 210 updates the amplitude of the object 110A at the wavelength λ(j). More specifically, the amplitude found through conversion from the intensity value of the hologram in step S101 is substituted in Equation (1) given below.

In step S104, the CPU 210 calculates back propagation to the object surface based on Equation (1) given below using the updated amplitude (interference fringe intensity data 10(j)) of the object 110A and the estimated interference fringe phase initial value data 20a.

[Equation 1]

E(x,y,0)=FFT⁻¹{FFT{E(x,y,z)}exp(i\sqrt{k²−kₓ²−k_{y}²z})} (1)

In the above Equation (1), E(x, y, 0) is a complex amplitude distribution of the object surface, E(x, y, z) is a complex amplitude distribution of the detecting surface, and z corresponds to propagation distance. k denotes wavenumber.

In step S105, the CPU 210 determines whether or not the value of ‘j+a’ falls within a range of J1 or greater and J2 or less. If the CPU 210 determines that the value of ‘j+a’ falls outside of the range of J1 or greater and J2 or less, processing proceeds to step S106. In step S106, the CPU 210 reverses the sign of ‘a’, and proceeds to step S107.

On the other hand, if the CPU 210 determines that the value of ‘j+a’ falls within the range of J1 or greater and J2 or less in step S105, processing proceeds to step S107.

In step S107, the CPU 210 increments or decrements by ‘j’ depending on whether ‘a’ is positive or negative.

In step S108, the CPU 210 updates the phase of the object 110A at the wavelength λ(j). More specifically, the phase is converted to a phase at the subsequent wavelength through calculation on a complex wavefront of the object surface calculated in step S104. Amplitude is not updated at this time.

In step S109, the CPU 210 calculates propagation to the detecting surface through calculation of optical wave propagation using Equation (2) given below, with only the phase of the image of the object 110A converted to that at the subsequent wavelength.

[Equation 2]

E(x,y,z)=FFT⁻¹{FFT{E(x,y,0)}exp(−i\sqrt{k²−kₓ²−k_{y}²z})} (2)

In the above Equation (2), E(x, y, 0) is a complex amplitude distribution on the object surface, E(x, y, z) is a complex amplitude distribution on the detecting surface, and z equals propagation distance. k denotes wavenumber.

In step S110, the CPU 210 determines whether the total sum of differences (namely errors) between amplitude Uj of the image of the object 110A calculated through optical wave propagation calculation and amplitude Ij calculated based on the intensity value of the interference fringe intensity data 10(j), which is a measured value at the wavelength λ(j), is less than a threshold value c, that is, whether the sum of the differences reaches a minimum value. Note that this determination step is an example of the evaluation function. If the CPU 210 determines that the total sum of differences is not less than the threshold value c, processing proceeds to step S111.

In step S111, the CPU 210 increases ‘n’ by one, and returns to step S103 in which the processing described above is performed repeatedly.

On the other hand, in step S110, if the total sum of differences is less than the threshold value c, the CPU 210 determines that the phase of the image of the object 110A is restored sufficiently, that is, the value has come close to the true value, completing the phase data calculation. In this manner, iterative approximation calculation is performed so that the evaluation function converges to the minimum, thereby acquiring the interference fringe phase estimated value data 30.

<(2) Learning Step of Constructing Initial Phase Estimator 300>

Next, the learning step for constructing the initial phase estimator 300 is described. In the learning step (2), a learned model equivalent to an image conversion function for approximating successive calculation, which calculates interference fringe phase estimated value data from the interference fringe intensity data of the image of the object, is constructed through machine learning. Details are described below.

[Exemplary Configuration of Computer 400]

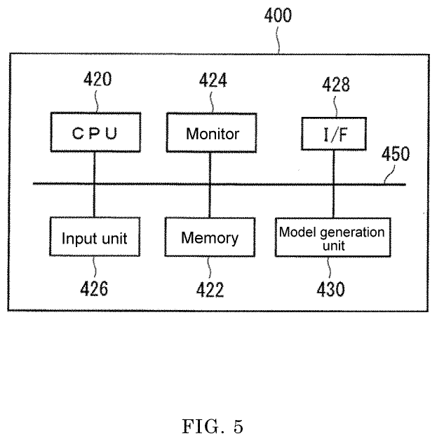

FIG. 5 is a block diagram illustrating an exemplary functional configuration of a computer 400 used when constructing the initial phase estimator 300. A personal computer or a work station in which, for example, a predetermined software (program) is installed, or a high-performance computer system connected to these computers via a communication line may be used as the computer 400.

As illustrated in FIG. 5, the computer 400 is an exemplary calculation unit, and includes a CPU 420, a storage unit 422, a monitor 424, an input unit 426, an interface 428, and a model generating unit 430. The CPU 420, the storage unit 422, the monitor 424, the input unit 426, the interface 428, and the model generating unit 430 are respectively connected to one another via a bus 450.

The CPU 420 executes a program stored in memory, such as ROM, or a program of the model generating unit 430 etc., thereby implementing machine learning etc. for controlling operations of the entire apparatus and generating a learned model.

The model generating unit 430 performs machine learning so as to construct a learned model for approximating successive calculation, which calculates interference fringe phase estimated value data from the interference fringe intensity data of the image of the object. With this embodiment, deep learning is used as the method for machine learning, and the convolutional neural network (CNN) is widely used. The convolutional neural network is a means for approximating an arbitrary image conversion function. Note that the learned model generated by the model generating unit 430 is stored in a computer 200B illustrated in FIG. 2, for example.

The storage unit 422 is configured by a non-volatile storage unit, such as ROM (Read only Memory), flash memory, EPROM (Erasable Programmable ROM), an HDD (Hard Disc Drive), and an SSD (Solid State Drive).

The monitor 424 is configured by a liquid crystal display or the like. The input unit 426 is configured by a keyboard, a mouse, a touch panel, etc., and performs various operations related to implementing machine learning. The interface 428 is configured by LAN, WAN, USB, etc., and performs two-way communication between the digital holography apparatus 100 and the computer 200B, for example.

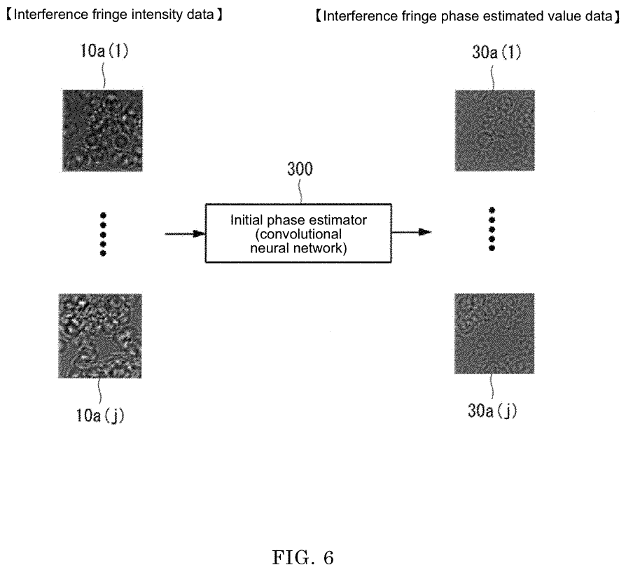

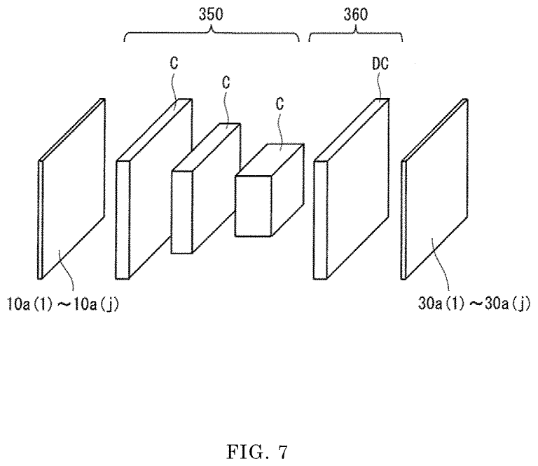

FIG. 6 is a diagram for describing an outline of a learning step of constructing the initial phase estimator 300. FIG. 7 illustrates an exemplary schematic configuration of a convolutional neural network 350 and a deconvolutional neural network 360 used when constructing the initial phase estimator 300.

As illustrated in FIG. 6 and FIG. 7, the learning data described using FIG. 3 is used for learning the connecting weight parameters of a neural network, such as the convolutional neural network 350. More specifically, the interference fringe intensity data 10a(1) to 10a(j) or physical quantity is used as input to the neural network, and the interference fringe phase estimated data 30a(1) to 30a(j) is used as output from the neural network. The interference fringe phase estimated data 30a(1) to 30a(j) is image data indicating values close to the true values at the phase of the image of the object 110A. Note that it may be a convolutional neural network using intensity data of a part of the wavelengths of the interference fringe intensity data 10a(1) to 10a(j) as input to the neural network.

The convolutional neural network 350 has multiple convolutional layers C. An example in which the number of convolutional layers C is three is described in FIG. 7; however, it is not limited thereto. The convolutional layers C apply convolution to the input interference fringe intensity data 10a(1) to 10a(j) by filtering the data, local features in the image are extracted, and a resulting feature amount map is output. The filter has elements, such as g×g pixels, and parameters, such as weight and bias. Note that ‘g’ denotes a positive integer.

The deconvolutional neural network 360 has a deconvolutional layer DC. An example of using a single deconvolutional layer DC is described in FIG. 7; however, it is not limited thereto. By performing convolutional operations or the like on the converted image converted by the convolutional layer C, the deconvolutional layer DC is enlarged to the same size as, for example, the interference fringe intensity data 10a(1) using the converted image as an input image. Respective filters of the deconvolutional layer DC have parameters of weight and bias.

In this manner, with the convolutional neural network 350, the connection and weight parameters of the neural network are learned using the learning data generated in the learning data generation step, so as to construct a learned model equivalent to an image conversion function, which approximates successive calculation of calculating interference fringe phase estimated value data using the interference fringe intensity data of the image of the object. The constructed learned model is stored in a learned model storage unit 238 indicated by a broken line in the computer 200B of FIG. 2.

<(3) Execution Step of Reconfiguring Images Through Phase Restoration>

An execution step of reconfiguring images based on phase restoration of the image of an object is described next. In the execution step (3), the learned model generated in the above-described step (2) as the initial phase estimator 300 is used to estimate appropriate phase data for an initial value used in iterative approximation calculation on new interference fringe intensity data of the image of the object. Details are described below.

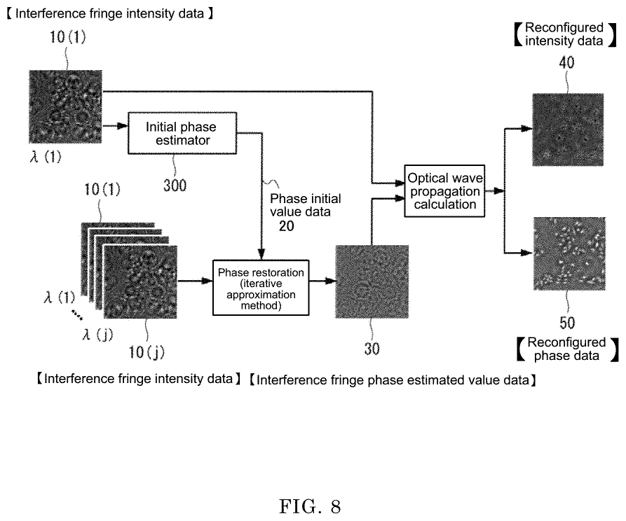

FIG. 8 illustrates an exemplary outline of a method of reconfiguring an image through phase restoration of the image of an object using the iterative approximation calculation according to the embodiment. A case of taking the image of an object 110B as new data using the digital holography apparatus 100 illustrated in FIG. 1, and executing a program for reconfiguring the image through phase restoration of the image of the object 110B using the computer 200B illustrated in FIG. 2, in the execution step, is described. Note that a means of taking the image of the object 110B may be an apparatus having the same function as the digital holography apparatus 100. Moreover, the computer 200B has common configuration and functions with the computer 200A, except for including the learned model storage unit 238 indicated by a broken line.

As illustrated in FIG. 8, the digital holography apparatus 100 irradiates the object 110B with lights of the different wavelengths λ(1) to λ(j) from the light sources, and acquires interference fringe intensity data 10(1) to 10(j) having different patterns. ‘j’ is a positive integer. Note that the interference fringe intensity data 10 of the image of the object 110B may be acquired ahead of time.

The computer 200B then sets appropriate phase data as the initial value to be used in iterative approximation calculation for the new input interference fringe intensity data 10(1) using as the initial phase estimator 300, the learned model stored in the learned model storage unit 238 indicated by a broken line in FIG. 2. As a result, the interference fringe phase initial value data 20 may be acquired as phase data close to the true value than that in the conventional case of using an arbitrary initial value.

Next, the computer 200B (CPU 210) performs iterative approximation calculation using the interference fringe intensity data 10(1) to 10(j) as the physical quantity of the object 110B and the interference phase initial value data 20, which is the initial phase value of the image of the object 110B, thereby calculating the interference fringe phase estimated value data 30 of the phase-restored image of the object 110B. An iterative approximation calculation algorithm may be applied to the respective processing of steps S101 to S111 of the flowchart of FIG. 4. In this manner, in order to minimize the evaluation function in step S110 of FIG. 4, the computer 200B successively updates the interference phase initial value data 20 as an approximate solution, and calculates the interference fringe phase estimated value data 30 of the image of the object 110B.

Then, the computer 200B performs optical wave propagation calculation using the interference fringe phase estimated value data 30 of the image of the object 110B obtained through phase restoration and the interference fringe intensity data 10(1) used as input data for the initial phase estimator 300, thereby acquiring reconfigured intensity data 40 and reconfigured phase data 50. The optical wave propagation calculation may use the operations of the respective steps described in FIG. 4, as well as Equation (1) and Equation (2) etc.

As described above, according to this embodiment, since in the execution step the initial phase value of the image of the object 110B, which will be used in iterative approximation calculation, is calculated by the initial phase estimator 300, which is constructed ahead of time by machine learning, convergence to an incorrect phase of the image of the object 110B may be avoided, and necessary number of times of repeating calculation until converging to the correct phase of the image of the object 110B may be reduced.

Moreover, according to the embodiment, since the phase data of the image of the object 110A estimated through iterative approximation calculation is generated as training data in the learning data generation step, even when the environment has changed and a new phase estimator needs to be constructed, it is possible to photograph in that environment so as to collect intensity information data, as well as generate phase information data necessary as learning data. This allows construction of an initial phase estimator 300 appropriate for the environment from which the data is acquired. Furthermore, since the phase of the image of the object 110A is calculated through iterative approximation calculation, a phase value close to the true value may be obtained, thereby constructing an initial phase estimator 300 with greater accuracy and stability.

Note that the technical range of the present invention is not limited to the embodiment described above, and various modifications thereto may be included as long as they fall within the scope of the present invention.

With the embodiment described above, while estimation of the initial value of a solution for a model relational expression is applied when regenerating an object image such as a cell, it is not limited thereto. For example, the present invention may be applied to image reconfiguration using PET apparatus, CT apparatus, etc., and to estimation of X-ray fluoroscopic scattered rays, as well as applied to the fields of chromatography, mass spectrum, etc. In the case of PET apparatus and X-ray CT apparatus, a radiation signal is input to the initial phase estimator 300, and a reconfigured tomographic image is output. In the case of estimation of X-ray fluoroscopic scattered rays, a radioscopic image (generated by radiation transmitting through the object) is input to the initial phase estimator 300, and a radioscopic image (having artifacts removed) is output.

Moreover, when the evaluation function used in step S110 is for X-ray images, for example, which require different indices, judgement may be made based on whether or not the evaluation function is maximized. In addition, an example of using a neural network for machine learning has been described in the above embodiment; however, not limited thereto, other machine learning using a support vector machine, boosting, etc. may be used.

Furthermore, the initial phase value of the image of the object used in iterative approximation calculation is not limited to one value and may be multiple values. In the case of using multiple initial values, iterative approximation calculation is performed using the multiple initial values, and the initial value having the best solution result is selected.

Yet further, instead of the interference fringe intensity data of the image of the object described above, a radioscopic image generated by radiation transmitting through the object may be used as the physical quantity to be used in iterative approximation calculation. In this case, the computer 200B performs iterative approximation calculation using the radioscopic image, thereby finding a reconfigured topographic image of the object.

### DESCRIPTION OF REFERENCES

10: Interference fringe intensity data (physical quantity)
20, 20a: Interference fringe phase initial value data
30: Interference fringe phase estimated value data
200A, 200B, 400: Computer (iterative approximation calculation apparatus, calculation unit)
210: CPU (calculation unit)
300: Initial phase estimator
350: Convolutional neural network (neural network)

1. An iterative approximation calculation method, comprising performing iterative approximation calculation to minimize or maximize an evaluation function,
the performing including using a learned model configured to receive inputs a predetermined physical quantity to be used in the iterative approximation calculation and to output one or more initial values to be used in the iterative approximation calculation.

2. The iterative approximation calculation method according to claim 1, wherein the physical quantity is interference fringe intensity of an object; and
in said step, phase information of the object is found through the iterative approximation calculation.

3. The iterative approximation calculation method according to claim 1, wherein the physical quantity is a radioscopic image generated by radiation transmitting through the object; and
in said step, a reconfigured tomographic image of the object is found through the iterative approximation calculation.

4. An iterative approximation calculation device, comprising a calculation unit for performing iterative approximation calculation so as to make an evaluation function either minimum or maximum, wherein
the calculation unit comprises a learned model, which inputs a predetermined physical quantity to be used in the iterative approximation calculation, and outputs one or a plurality of initial values to be used in the iterative approximation calculation.

5. The iterative approximation calculation device according to claim 4, wherein the physical quantity is interference fringe intensity of an object; and
the calculation unit finds phase information of the object through the iterative approximation calculation.

6. The iterative approximation calculation device according to claim 4, wherein the physical quantity is a radioscopic image generated by radiation transmitting through the object; and
the calculation unit finds a reconfigured tomographic image of the object through the iterative approximation calculation.

7. A program being executed by a computer, the program comprising the function of performing iterative approximation calculation so as to make an evaluation function either minimum or maximum, wherein the iterative approximation calculation uses a learned model, which inputs a predetermined physical quantity to be used in the iterative approximation calculation, and outputs one or a plurality of initial values to be used in the iterative approximation calculation.
